(19) United States
(12) Patent Application Publication
(10) Pub. No.: US 2025/0201994 A1
(43) Pub. Date: Jun. 19, 2025

(54) BATTERY MOUNTING DEVICE

(71) Applicant: Honda Motor Co., Ltd., Tokyo (JP)

(72) Inventors: Tatsunori HATTORI, Tokyo (JP); Genta URASAKI, Tokyo (JP); Gaku ISHIZUKA, Tokyo (JP); Kento MORITA, Tokyo (JP)

(73) Assignee: Honda Motor Co., Ltd., Tokyo (JP)

(21) Appl. No.: 18/979,504

(22) Filed: Dec. 12, 2024

(30) Foreign Application Priority Data
Dec. 14, 2023 (CN) 202311719517.1

(51) Int. Cl. H01M 50/209; H01M 50/264

(52) U.S. Cl. CPC H01M 50/209; H01M 50/264

(57) ABSTRACT

A battery mounting device is used to configure a stacked battery module on a housing. Multiple battery units and a plate member are stacked in the stacked battery module. The plate member is disposed at both ends in a stacking direction of the battery units, and the housing has a fastening hole for fastening the stacked battery module. The battery mounting device includes: a main body; a clamping claw, engaged with the plate member; and a pin member, inserted into the insertion hole disposed in the plate member, and at least two pin members are disposed at both ends in the stacking direction. The pin member is floatingly mounted to the main body and inserted into the insertion hole to be in contact with the fastening hole of the housing, thereby positioning the insertion hole and the fastening hole.

### CROSS-REFERENCE TO RELATED APPLICATION

This application claims the priority benefit of China application serial no. 202311719517.1, filed on Dec. 14, 2023. The entirety of the above-mentioned patent application is hereby incorporated by reference herein and made a part of this specification.

### BACKGROUND

### Technical Field

The disclosure relates to a battery mounting device, and in particular to a battery mounting device for assembling stacked battery modules.

### Description of Related Art

In recent years, in order to ensure access to affordable, reliable, sustainable, and advanced energy for more people, research and development related to secondary batteries that contribute to energy efficiency has been carried out.

Unlike primary batteries that cannot be recharged, secondary batteries refer to batteries that can be charged and discharged, and are being used as power sources for energy storage systems (ESS), electric vehicles (EV), or hybrid electric vehicles (HEV), and small high-tech electronic devices (such as mobile phones, personal digital assistants (PDAs), and laptop computers).

Currently, one secondary battery (cell) cannot give an output sufficient to drive an electric vehicle. In order to use secondary batteries as energy sources for electric vehicles (for example, a battery module having multiple lithium-ion battery modules connected in series and/or in parallel should be configured), and typically, a battery pack is configured to include a battery management system (BMS), a cooling system, a battery disconnection unit (BDU), electrical wiring cables, etc. for connecting the battery modules in series and functionally maintaining the battery modules.

However, in the technology related to the secondary batteries, how to efficiently position the mounting position of related workpieces with high accuracy during the device assembly process and how to efficiently mount the workpieces are important issues.

In terms of the prior art for efficiently mounting workpieces, Patent Literature 1 (Japanese Patent Application Publication No. 2017-165217) discloses a workpiece mounting device, which is positioned and connected by being engaged with a frame member of a vehicle through a pin-shaped joint portion provided on a connecting arm of a connecting mechanism portion, so that on an assembly line for conveying workpieces for assembling vehicles, the mounting position of the workpiece on the vehicle body can be easily and accurately positioned, and the workpiece can be efficiently mounted.

However, on the assembly line that conveys battery modules to assemble battery packs, the assembly process is as follows: in the battery pack, a housing of the battery pack is provided with a fastening hole on a side of the battery module for fastening the battery module, the fastening holes of the housing are aligned with the insertion holes on the side of the housing in the battery module, and the battery modules may be mounted after being fixed with bolts. However, since the fastening holes of the housing and the insertion holes of the battery module need to be overlapped, no deviation in positioning is allowed, otherwise the holes may be covered, which places higher requirements on positioning accuracy. Due to the different processing standards for the fastening holes of the housing and the insertion holes of the battery module, under the current specifications, the positions of the reference holes of the battery module and the tapping processing references of the housing do not completely match. Considering the error in processing accuracy, the holes may be misaligned and covered. In addition, on the assembly line for assembling the battery pack, the stacked battery modules need to be aligned and then rotated for fixation, so positioning may need to be performed simultaneously in different directions.

In the disclosure, efficient assembly of a battery pack is achieved. Furthermore, it contributes to the energy efficiency.

### SUMMARY

The disclosure provides a battery mounting device. The battery mounting device is used to configure a stacked battery module on a housing. Multiple battery units and a plate member are stacked in the stacked battery module. The plate member is disposed at both ends in a stacking direction of the battery units. The housing has a fastening hole for fastening the stacked battery module. The battery mounting device comprises: a main body; a clamping claw, disposed on the main body and engaged with the plate member; and a pin member, disposed on the main body and inserted into the insertion hole disposed on the plate member, and at least two pin members are disposed at both ends in the stacking direction. The pin member is floatingly mounted to the main body, and the pin member inserted into the insertion hole is in contact with the fastening hole of the housing, thereby positioning the insertion hole and the fastening hole.

To make the aforementioned more comprehensible, several embodiments accompanied with drawings are described in detail as follows.

### BRIEF DESCRIPTION OF THE DRAWINGS

FIG. 1 is a separated schematic diagram of a housing and a stacked battery module of a battery pack according to an embodiment of the disclosure.

FIG. 2 is a schematic diagram of a battery mounting device according to an embodiment of the disclosure.

FIG. 3A is a schematic diagram of the battery mounting device shown in FIG. 2 when holding the stacked battery module.

FIG. 3B is an enlarged schematic diagram of the adjacent area of the pin member of FIG. 3A.

FIG. 4A is a schematic diagram of the battery mounting device shown in FIG. 2 when the stacked battery module is configured in a housing.

FIG. 4B is an enlarged schematic diagram of the adjacent area of the pin member of FIG. 4A.

FIG. 4C is an enlarged schematic diagram of the adjacent area when the pin member of FIG. 4A is in contact with the fastening hole.

### DESCRIPTION OF THE EMBODIMENTS

The disclosure provides a battery mounting device which can easily and accurately aligning an insertion hole and a fastening hole for fastening a stacked battery module in a battery pack.

In an embodiment of the disclosure, a front end of the pin member has a tapered shape that gradually tapers toward a center.

In an embodiment of the disclosure, a diameter of the pin member is smaller than a diameter of the insertion hole and larger than a diameter of the fastening hole.

In an embodiment of the disclosure, four pin members are provided, and the four pin members are respectively disposed at both ends of the plate member in a width direction and both ends in the stacking direction. The pin members are inserted into the insertion holes and abut against the fastening holes at the same time.

Based on the above, in the battery mounting device of the embodiment of the disclosure, since the pin member is floatingly mounted to the main body and may be positioned in a floating manner, when the pin member is in contact with the fastening hole, axes of the insertion hole and the fastening hole are aligned, thereby making it easy to position the housing and the stacked battery module and prevent the hole from being covered, so as to facilitate the easy and high-accuracy positioning of the mounting position of the stacked battery module on the assembly line of the battery pack and mount the stacked battery module efficiently.

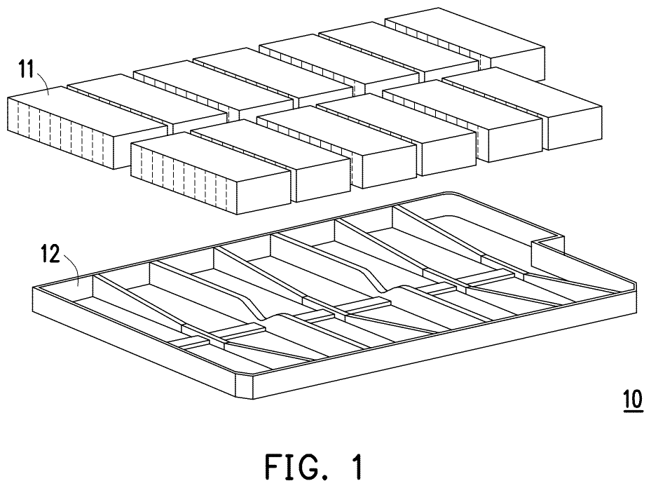

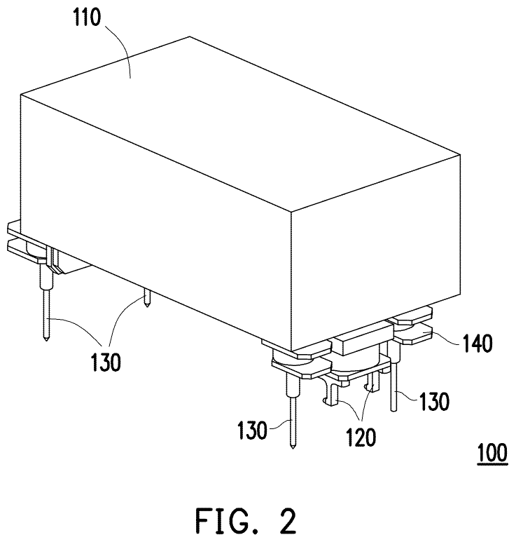

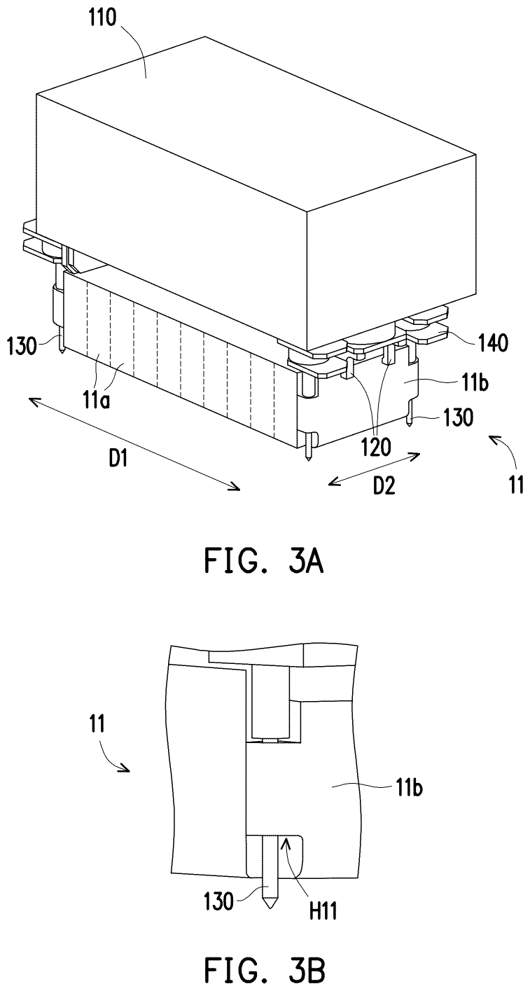

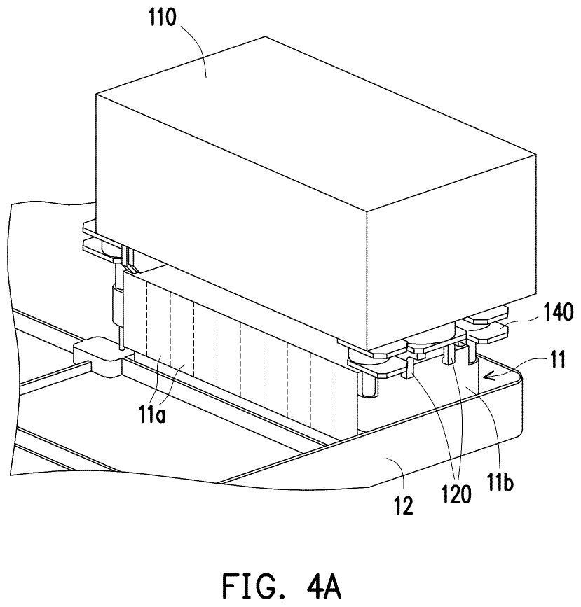

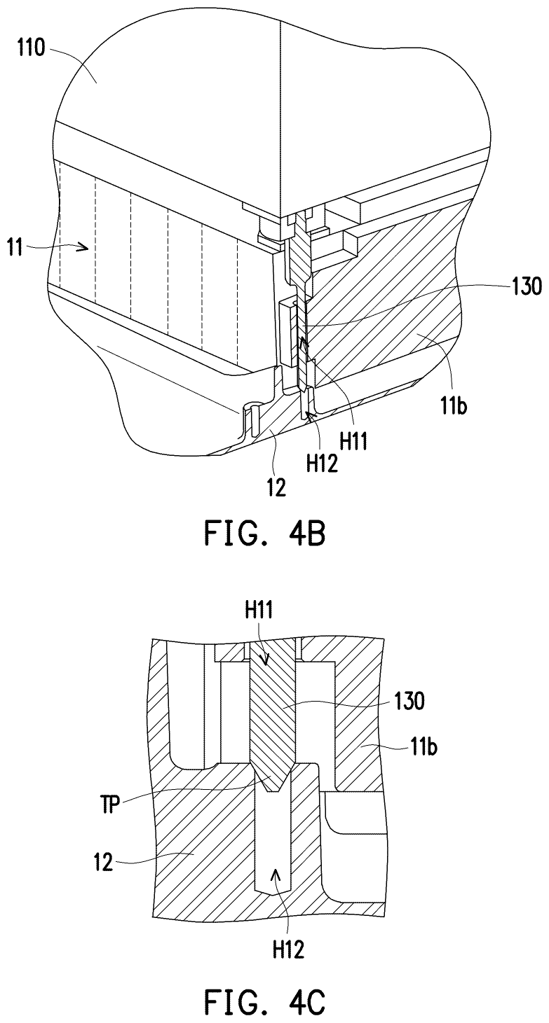

FIG. 1 is a separated schematic diagram of a housing and a stacked battery module of a battery pack according to an embodiment of the disclosure; FIG. 2 is a schematic diagram of a battery mounting device according to an embodiment of the disclosure; FIG. 3A is a schematic diagram of the battery mounting device shown in FIG. 2 when holding the stacked battery module; FIG. 3B is an enlarged schematic diagram of the adjacent area of the pin member of FIG. 3A; FIG. 4A is a schematic diagram of the battery mounting device shown in FIG. 2 when the stacked battery module is configured in a housing; FIG. 4B is an enlarged schematic diagram of the adjacent area of the pin member of FIG. 4A; FIG. 4C is an enlarged schematic diagram of the adjacent area when the pin member of FIG. 4A is in contact with the fastening hole.

Referring to FIG. 1 to FIG. 4C, in this embodiment, a battery mounting device 100 is used to arrange a stacked battery module 11 on a housing 12 so as to assemble the stacked battery module 11 into a battery pack 10. Specifically, as shown in FIG. 1, FIG. 3A, and FIG. 4A to FIG. 4C, in the process of assembling the stacked battery module 11 into the battery pack 10, the stacked battery module 11 need to be transferred to the top of the housing 12. As shown in FIG. 3A, multiple battery units 11a and a plate member 11b are stacked in the stacked battery module 11, and the plate member 11b is disposed at both ends in a stacking direction D1 of the battery units 11a. As shown in FIG. 4B and FIG. 4C, the plate member 11b is provided with an insertion hole H11 on a side close to the housing 12. The housing 12 is provided with a fastening hole H12 on a side close to the stacked battery module 11 for fastening the stacked battery module 11. As shown in FIG. 4C, in the battery pack 10, the fastening hole H12 of the housing 12 is aligned with the insertion hole H11 disposed on the side of the housing 12 in the stacked battery module 11. In this way, the stacked battery module 11 may be mounted after being fixed with bolts.

Furthermore, as shown in FIG. 2, in this embodiment, the battery mounting device 100 includes a main body 110, a clamping claw 120, a pin member 130, and a floating member 140. The clamping claw 120 and the pin member 130 are both disposed on the main body 110, and the pin member 130 is floatingly mounted to the main body 110 via the floating member 140. As shown in FIGS. 3A and 3B, when the stacked battery module 11 is transferred to the top of the housing 12, the clamping claw 120 of the battery mounting device 100 may be engaged with the plate member 11b to hold the stacked battery module 11. In addition, in this embodiment, at least two pin members 130 are provided at both ends in the stacking direction D1, so that the pin members 130 may be inserted into the insertion hole H11 disposed in the plate member 11b to position the battery mounting device 100 relative to the stacked battery module 11.

Further, as shown in FIGS. 4A to 4C, when the stacked battery module 11 is configured on the housing 12, the pin member 130 floats during installation, allowing the pin member 130 to be inserted into the insertion hole H11 to be in contact with the fastening hole H12 of the housing 12, thereby calibrating and positioning the insertion hole H1l and the fastening hole H12 accordingly. As shown in FIG. 4C, the fastening holes H12 of the housing 12 and the insertion holes H11 of the stacked battery module 11 disposed on the housing 12 side may be aligned with high accuracy, and then are easily fixed with bolts and complete the mounting of the stacked battery module 11.

In this way, since the pin member 130 may be positioned in a floating manner, when the pin member 130 is in contact with the fastening hole H12, axes of the insertion hole H11 and the fastening hole H12 are aligned, thereby making it easy to position the housing 12 and the stacked battery module 11 and prevent the hole from being covered, so as to facilitate the easy and high-accuracy positioning of the mounting position of the stacked battery module 11 on the assembly line of the battery pack 10, and mount the stacked battery module 11 efficiently.

In addition, as shown in FIG. 4C, in the present embodiment, a front end TP of the pin member 130 has a tapered shape that tapers toward the center, and a diameter of the pin member 130 is smaller than a diameter of the insertion hole H11 and larger than a diameter of the fastening hole H12. Since the diameter of the pin member 130 is larger than the diameter of the fastening hole H12 of the housing 12, the axes may be aligned by bringing a tapered surface of the front end TP of the pin member 130 into contact with an edge of the fastening hole H12 of the housing 12. Furthermore, when the tapered surface of the front end TP of the pin member 130 is in contact with the edge of the fastening hole H12 of the housing 12, the pin member 130 may be positioned in a manner that the axis is centered, so that the fastening hole H12 of the housing 12 is aligned with the axis of the insertion hole H11 disposed on the side of the housing 12 in the stacked battery module 11. In this way, the positioning accuracy can be further improved.

On the other hand, in this embodiment, preferably, four pin members 130 may be disposed, as shown in FIG. 4A, and the four pin members 130 are respectively disposed at both ends of a width direction D2 of the plate member 11b and at both ends of the stacking direction D1. Furthermore, the pin members 130 are inserted into the insertion hole H11 and abut against the fastening hole H12 at the same time. In this way, by configuring the four pin members 130, four positions may be aligned at the same time, and positioning in the longitudinal and transverse rotational directions may be performed at the same time, making the positioning process of assembling the battery pack 10 easier.

To sum up, in the battery mounting device of the embodiment of the disclosure, since the pin member is floatingly mounted to the main body and may be positioned in the floating manner, when the pin member is in contact with the fastening hole, the axes of the insertion hole and the fastening hole are aligned, thereby making it easy to position the housing and the stacked battery module and prevent the hole from being covered, so as to facilitate the easy and high-accuracy positioning of the mounting position of the stacked battery module on the assembly line of the battery pack and mount the stacked battery module efficiently.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A battery mounting device, configured to arrange a stacked battery module on a housing, wherein the stacked battery module is stacked with a plurality of battery units and a plate member, the plate member is arranged at both ends in a stacking direction of the plurality of battery units, the housing has a fastening hole for fastening the stacked battery module, the battery mounting device comprises:
a main body;
a clamping claw, disposed on the main body and engaged with the plate member; and
a pin member, disposed in the main body and inserted into an insertion hole disposed in the plate member, and
at least two pin members are disposed at both ends in the stacking direction,
the pin member is floatingly mounted to the main body,
the pin member inserted into the insertion hole is in contact with the fastening hole of the housing, thereby positioning the insertion hole and the fastening hole.

2. The battery mounting device according to claim 1, wherein a front end of the pin member has a tapered shape which gradually tapers toward a center.

3. The battery mounting device according to claim 2, wherein a diameter of the pin member is smaller than a diameter of the insertion hole and larger than a diameter of the fastening hole.

4. The battery mounting device according to claim 1, wherein
four pin members are provided, the four pin members are respectively disposed at both ends of the plate member in a width direction and both ends in the stacking direction, and the pin members are inserted into the insertion holes and abut against the fastening holes at the same time.

5. The battery mounting device according to claim 2, wherein
four pin members are provided, the four pin members are respectively disposed at both ends of the plate member in a width direction and both ends in the stacking direction, and the pin members are inserted into the insertion holes and abut against the fastening holes at the same time.

6. The battery mounting device according to claim 3, wherein
four pin members are provided, the four pin members are respectively disposed at both ends of the plate member in a width direction and both ends in the stacking direction, and the pin members are inserted into the insertion holes and abut against the fastening holes at the same time.
